(19) United States
(12) Patent Application Publication
(10) Pub. No.: US 2019/0059319 A1
(43) Pub. Date: Feb. 28, 2019

(54) PET FEEDING DEVICE

(71) Applicant: PAWBO INC., Taipei City (TW)

(72) Inventors: Hung-Chin Hsiao, Taipei City (TW); Chih-Hsien Teng, Taipei City (TW); Chin-Fu Huang, Taipei City (TW); Guo-Lin Tian, Taipei City (TW)

(73) Assignee: PAWBO INC., Taipei City (TW)

(21) Appl. No.: 15/884,396

(22) Filed: Jan. 31, 2018

(30) Foreign Application Priority Data
Aug. 30, 2017 (TW) 106129518

(51) Int. Cl. A01K 5/01

(52) U.S. Cl. CPC A01K 5/0114

(57) ABSTRACT

A pet feeding device including a base, a driving assembly, and a container is provided. The base has a first opening and a transmission tunnel in communication with the first opening. The driving assembly and the container are disposed inside the base. The container has a rotating shaft connected with the driving assembly to be driven to rotate in the base. The container has a second opening having an adjustable opening size. The transmission tunnel is located on a movement path of the second opening. A feeding object is adapted to be received by the container via the second opening. The feeding object is dropped to the transmission tunnel via the second opening when the container is rotated to move the second opening past the transmission tunnel. The feeding object is moved along the transmission tunnel and transferred out of the pet feeding device via the first opening.

### CROSS-REFERENCE TO RELATED APPLICATION

This application claims the priority benefit of Taiwan application serial no. 106129518, filed on Aug. 30, 2017. The entirety of the above-mentioned patent application is hereby incorporated by reference herein and made a part of this specification.

### BACKGROUND

### 1. Technical Field

The disclosure relates to a pet feeding device.

### 2. Description of Related Art

Nowadays, keeping pets, such as cats, dogs, and pet mice, has become much more common, and pet-related products have become much more diversified. In general, these products are mainly designed to make it easier for the pets to use and for the owners to clean or replace. Common products include pet houses, beds, food containers, and water containers, and the like.

Taking food containers as an example, the conventional containers are mostly bowl-shaped or plate-shaped and provide a space for placement of food, so that the owners may place food in the containers to feed the pets. However, when dogs and cats eat the food, they mostly use their mouths and noses to push the food into their mouths, and with such a way of eating, the food may be pushed to the edge of the container when less food remains in the container. As a consequence, the dogs and cats may not be able to eat the remaining food and the food may be spread out of the container. Besides, the amount of food eaten by the pets is not controllable with the containers. If the pets are ill and need to be fed with drugs, the owners need to control the amount of drugs, making drug-feeding less convenient.

### SUMMARY

The disclosure provides a pet feeding device with a structure capable of making adjustment according to different forms of food and a feeding mechanism feeding a pet in a predetermined amount and at a predetermined time.

A pet feeding device according to an embodiment of the disclosure includes a base, a driving assembly, and a container. The base has a first opening and a transmission tunnel in communication with the first opening. The driving assembly and the container are respectively disposed inside the base. The container has a rotating shaft connected with the driving assembly to be driven to rotate in the base.

The container has a second opening having an adjustable opening size, and the transmission tunnel is located on a movement path of the second opening. A feeding object is adapted to be received by the container via the second opening. The feeding object is dropped to the transmission tunnel via the second opening when the container is rotated to move the second opening past the transmission tunnel, and the feeding object is moved out via the first opening along the transmission tunnel.

Based on the above, with a corresponding arrangement of the container and the transmission tunnel and the second opening of the container having an adjustable opening size, the user may place the feeding object into the container via the second opening and adjust the second opening of the pet feeding device to a desired opening size. Therefore, when the container is driven by the driving assembly of the pet feeding device to rotate about an axis and the second opening is moved past the transmission tunnel, the feeding object in the container may be moved out of the container (i.e., dropped out of the container) via the second opening. In addition, the dropped feeding object may be moved out via the first opening through the transmission tunnel for the pet to eat.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a pet feeding device according to an embodiment of the disclosure.

FIG. 2 is an exploded view illustrating some components in the pet feeding device of FIG. 1.

FIGS. 3A and 3B are schematic views respectively illustrating a driving assembly from different perspectives.

FIG. 4 is a view illustrating a connection relation between relevant components in FIGS. 1 and 2.

FIGS. 5 and 6 are respectively schematic views illustrating some components of the pet feeding device of FIG. 1.

FIG. 7 is a schematic view illustrating the pet feeding device in another state.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

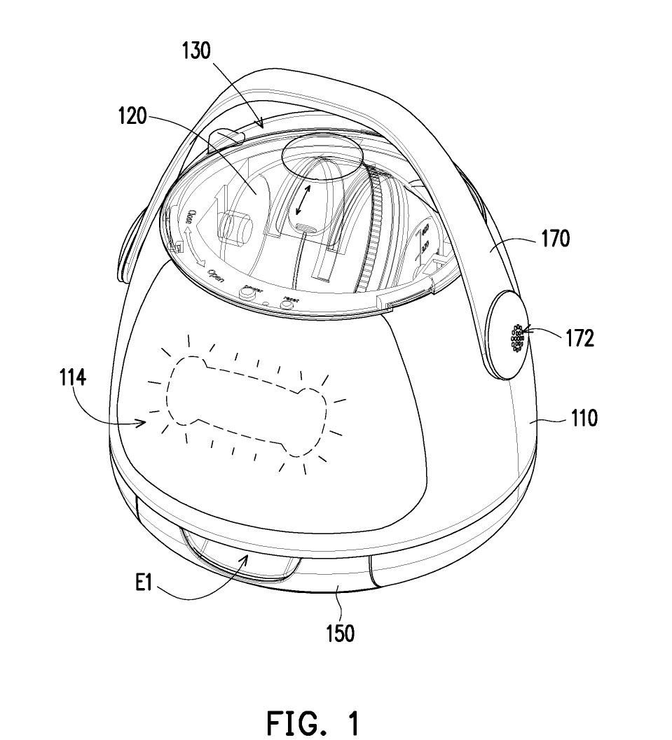

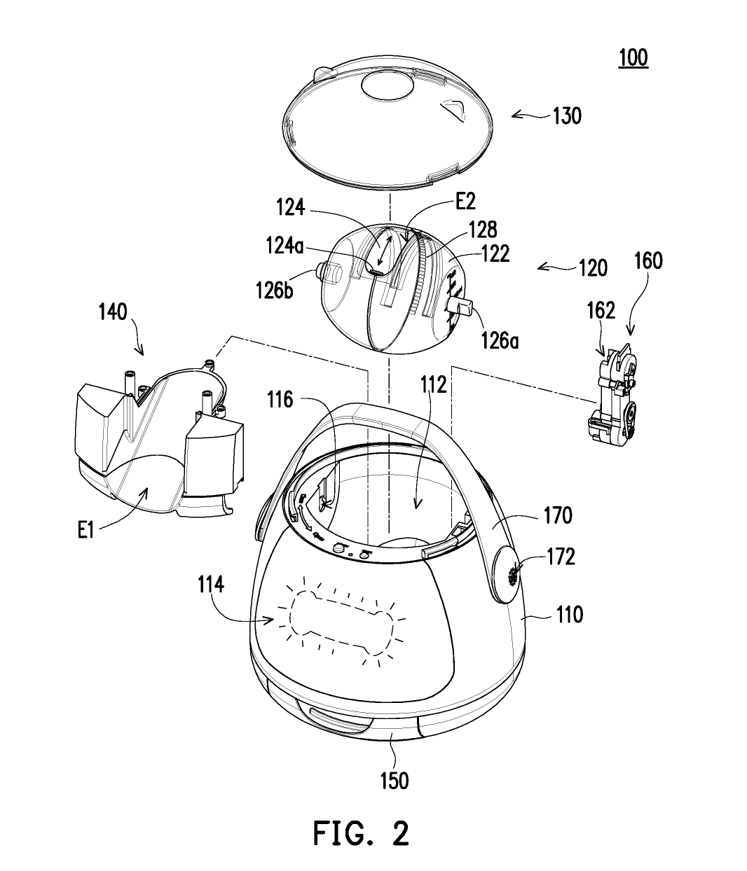

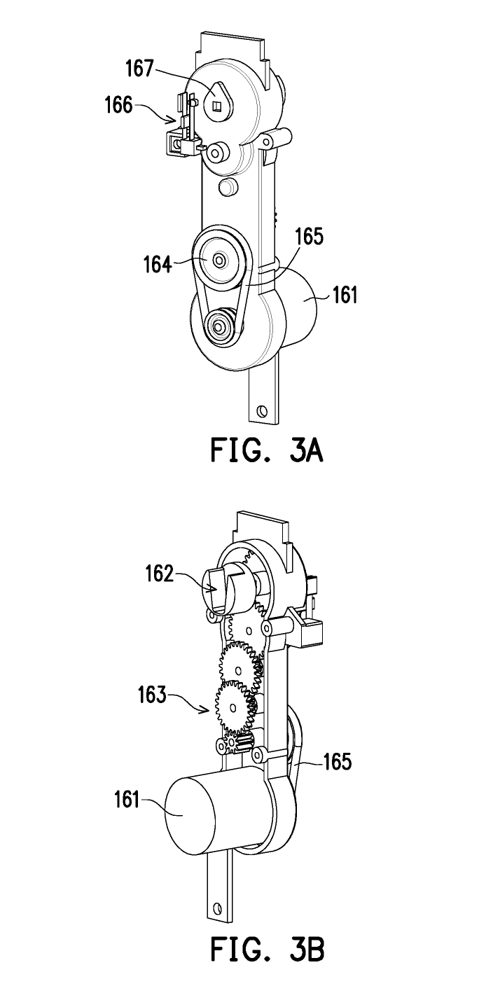

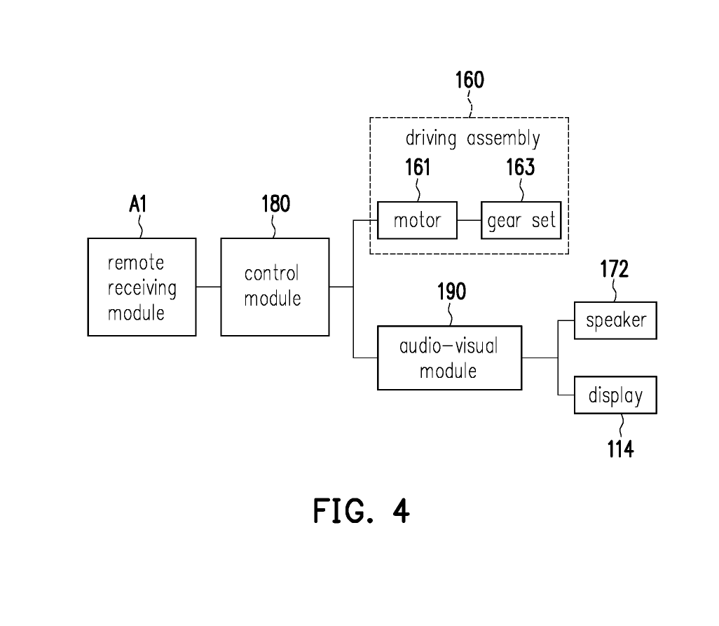

FIG. 1 is a schematic view illustrating a pet feeding device according to an embodiment of the disclosure. FIG. 2 is an exploded view illustrating some components in the pet feeding device of FIG. 1. FIGS. 3A and 3B are schematic views respectively illustrating a driving assembly from different perspectives. FIG. 4 is a view illustrating a connection relation between relevant components in FIGS. 1 and 2. Referring to FIGS. 1 to 4, in the embodiment, a pet feeding device 100 is adapted for a user to feed a pet. The pet feeding device 100 includes a base 110, a top cover 130, a transmission tunnel 140, a driving assembly 160, and a container 120. The top cover 130 is assembled to the base 110. The base 110 has a first opening E1. The transmission tunnel 140 is disposed inside the base 110 and in communication with the first opening E1. The driving assembly 160 is disposed inside the base 110 and includes transmission components such as a motor 161, a transmission wheel 164, a transmission belt 165, a gear set 163, and the like. The container 120 is in a spherical shape, and has rotating shafts 126a and 126b. The rotating shaft 126a is connected with and driven by the driving assembly 160, so that the container 120 is rotated in an internal space 112 of the base 110.

More specifically, a pivoting groove 116 is provided in the internal space 112 of the base 110, so that the rotating shaft 126b of the container 120 is pivoted in the pivoting groove 116. An engaging groove 162 exposed to the internal space 112 is provided in the driving assembly 160 disposed inside the base 110, so that the rotating shaft 126a is engaged and fixed to the engaging groove 162. In addition, the motor 161 drives the gear set 163 through the transmission wheel 164 and the transmission belt 165, so that the engaging groove 162 is rotated accordingly. For example, the engaging groove 162 is provided in a gear and the engaging groove 162 is rotated with the gear. Consequently, the container 120 is driven by the driving assembly 160 to rotate about an axis in the internal space 112.

Referring to FIGS. 1, 2, and 4, in the embodiment, the pet feeding device 100 further includes a control module 180 and an audio-visual module 190. The motor 161 of the driving assembly 160 is electrically connected with the control module 180 to drive the gear assembly 163 accordingly. The audio-visual module 190 is electrically connected with the control module 180 and drives a speaker 172 and a display 114. Consequently, when the driving assembly 160 drives the container 120 to rotate under control of the control module 180, the audio-visual module 190 may also provide an audio-visual signal via the speaker 172 and the display 114 under control of the control module 180 to draw the pet's attention. Therefore, by sending out the audio-visual signal, the pet feeding device 100 is able to notify the pet to eat or perform relevant training. Besides, the user may drive the pet feeding device 100 via wired control (e.g., a physical switch or button) or wireless control (e.g., infrared control).

Meanwhile, the pet feeding device 100 of the embodiment further includes a remote receiving module A1. The remote receiving module A1 receives a wireless signal and drives the pet feeding device 100 accordingly. In other words, with the remote receiving module A1 of the pet feeding device 100, the user is still able to control rotation of the container and transmit the audio-visual signal when away from the pet, so as to achieve remote control and make the device more convenient. For example, the remote receiving module A1 may be directly disposed to the pet feeding device 100, or the remote receiving module A1 is set in a host disposed beside or within a distance from the pet feeding device 100. After the remote receiving module A1 of the host receiving a user signal and then the host may drive the pet feeding device via remote control. Here, the disclosure does not intend to limit the means of remote control.

In addition, as shown in FIGS. 1 and 2, in the embodiment, the top cover 130 assembled to the base 110 is transparent, and the container 120 is also transparent. Therefore, the user is able to clearly determine the amount of feeding objects in the container 120 visually, so as to decide whether to add more feeding objects to the container 120. The pet feeding device 100 of the embodiment further includes a handle 170. The handle 170 is pivoted to opposite two sides of the base 110, and the speaker 172 is disposed at where the handle 170 and the base 110 are pivoted.

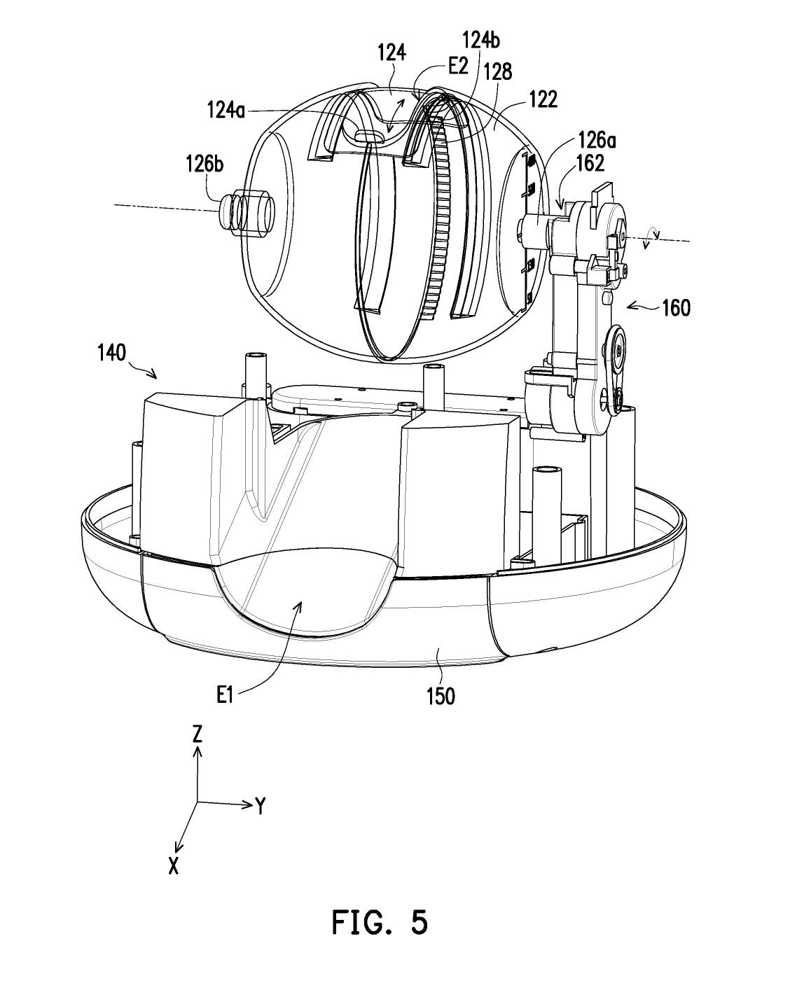

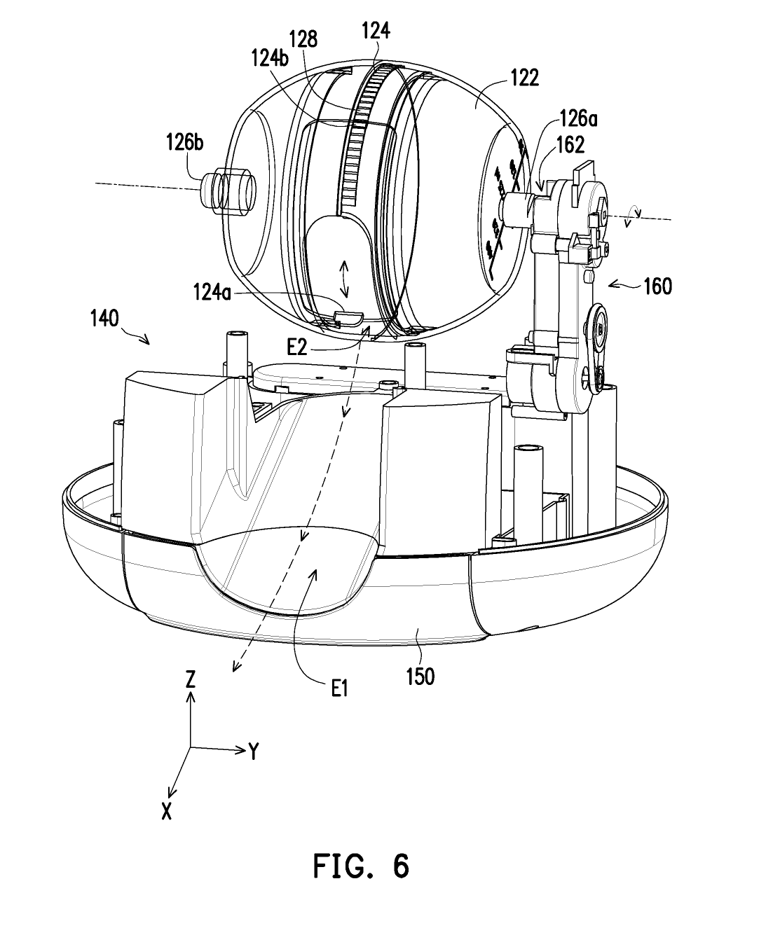

FIGS. 5 and 6 are respectively schematic views illustrating some components of the pet feeding device of FIG. 1. A Cartesian coordinates system is provided herein to describe the components more easily. Referring to FIGS. 2, 5, and 6, in the embodiment, the container 120 includes a body 122 and a baffle 124. The body 122 has a second opening E2, and the body 122 has a space to receive and contain the feeding objects. In addition, the second opening E2 is provided for communication between the space in the base and an external environment. The rotating shafts 126a and 126b are respectively disposed on a tangent plane at two opposite sides of the body 122, and extend in directions away from the space of the body 122 (i.e., extend outward from the body 122). Therefore, after the rotating shaft 126a is engaged to the engaging groove 162 of the driving assembly 160 and the rotating shaft 126b is pivoted to the pivoting groove 116 on an inner wall of the base 110 (as shown in FIG. 2), the driving assembly 160 may drive the container 120 to rotate uniaxially in the base 110, as shown by an axis and an arrow sign for rotation shown in FIGS. 5 and 6. Consequently, the second opening E2 may be rotated with the container 120.

Moreover, the transmission tunnel 140 of the embodiment is disposed inside the base 110 and exactly below the container 120. Therefore, the transmission tunnel 140 is substantially located on a movement path of the second opening E2. Specifically, the baffle 124 is movably connected to track grooves disposed to the body 122 and located beside the second opening E2. Therefore, by moving the baffle 124 relative to the body 122, the second opening E2 may be opened and closed, as indicated by the double-headed arrow sign marked at the baffle 124 in the drawings. In other words, based on a movement position of the baffle 124, an opening size of the second opening E2 is adjustable. Meanwhile, the body 122 also has a plurality of positioning notches 128 disposed on an inner wall of the body 122, and the baffle 124 has a protrusions 124. In addition, the positioning notches 128 are arranged along a movement path of the positioning protrusion 124b. Therefore, when the user exerts a force to a pushing stem 124a to move the baffle 124, the second opening E2 may be maintained in a desired opening size by temporarily engaging the positioning protrusion 124b to one of the positioning notches 128. Accordingly, the second opening E2 may be adjusted to accommodate shapes of various feeding objects (e.g., food or drugs). In other words, the feeding objects received by the container 120 are no longer limited by the shapes of the feeding objects, so the applicability of the pet feeding device 100 with respect to the feeding objects is facilitated.

Hence, when the second opening E2 faces upward (i.e., facing toward the positive Z-axis direction, during which time the transmission tunnel 140 is located exactly below the container 120), the user may place the feeding objects in the space inside the container 120 via the second opening E2 by opening the top cover 130 and driving the baffle 124 to open the second opening E2. Then, the user may exert a force on the pushing stern 124a to move the baffle 124, so as to maintain the desired opening size of the second opening E2, such as a size allowing only one feeding object to pass through (but the disclosure is not limited thereto). When the container 120 is rotated and the second opening E2 is moved past over the transmission tunnel 140, the feeding object may be dropped into the transmission tunnel 140 from the container 120 via the second opening E2 due to gravity. Then, since the transmission tunnel 140 is inclined, the feeding object dropped to the transmission tunnel 140 may be further dropped out of the pet feeding device 100 through the transmission tunnel 140 via the first opening E1. Here, a movement path of the feeding object is shown in a broken line with arrow signs.

It should be noted that, in the embodiment, dropping of the feeding object may be controlled through a rotation mode of the container 120. Referring to FIGS. 3A and 3B, the pet feeding device 100 of the embodiment further includes a sensor 166, such as a position-limiting switch, disposed beside the rotating shaft 126b and electrically connected to the control module 180 and a poke block 167 disposed beside the rotating shaft 126b. The poke block 167 is substantially rotated synchronously (such as being disposed at different sides of the same gear) with the engaging groove 162 (the rotating shaft 162b), and the sensor 166 is located on a movement path of the poke block 167. When the sensor 166 contacts and senses the poke block 167, the driving assembly 160 may stop driving the container 120 under control of the control module 180. In the embodiment, it is set that the second opening E2 faces upward and the transmission tunnel 140 is located exactly below the container 120 during a sensing state when the sensor 166 senses the poke block 167, as shown in FIG. 4. In the state, it is suitable for the user to add feeding objects. Then, the driving assembly 160 drives the container 120 to rotate. Therefore, in a state shown in FIG. 5 (equivalent to a state where the container 120 rotates half a circle), the second opening E2 faces downward to drop the feeding object. In the state, the sensor does not sense or contact the poke block 167. Therefore, the control module 180 still continuously operates the driving assembly 160. The control module 180 stops driving the container 120 to rotate when the state described above is reached and the container 120 completes a full circle of rotation to keep the second opening E2 face upward again. Therefore, the user may control the number of circles that the container 120 rotates as well as the opening size of the second opening E2 to control the amount of the feeding objects dropped. It should also be noted that the audio-visual module 190 may also provide a corresponding audio-visual signal in correspondence with the rotation mode of the container 120.

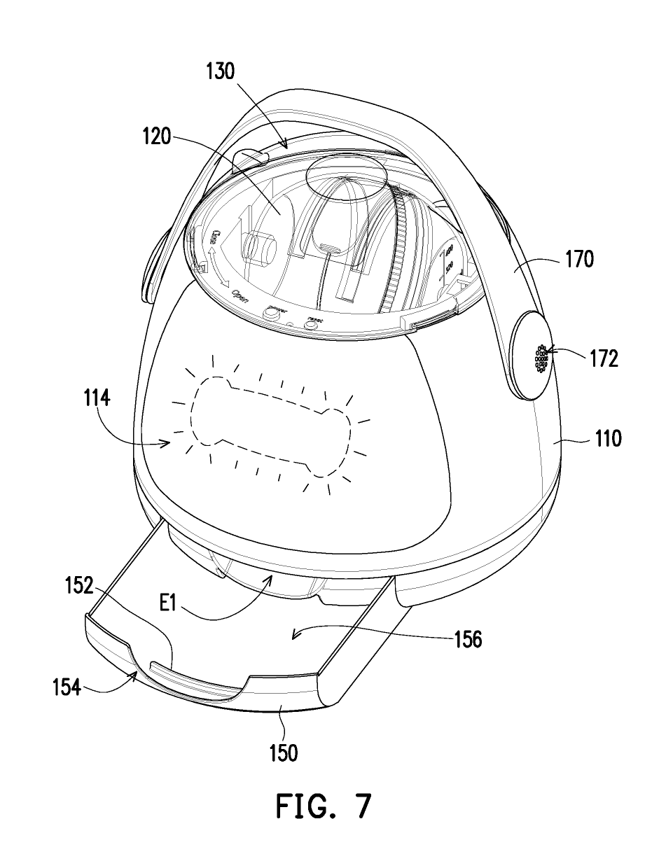

FIG. 7 is a schematic view illustrating the pet feeding device in another state. Referring to FIGS. 1 and 7, in the embodiment, the pet feeding device 100 further includes a drawer 150. The drawer 150 is movably disposed at the bottom of the base 110 to be accommodated in or drawn out of the base 110. When the drawer 150 is accommodated in the base (as shown in FIG. 1), an outer surface of the drawer 150 partially (i.e., a side edge 154) surrounds the first opening E1 and conforms to a profile of an outer surface of the base 110. Besides, the drawer 150 has a stopper 152 disposed on an inner surface. When the drawer 150 is drawn out of the base 110, the stopper 152 is located on a movement path of the feeding object (reference is made to the movement path shown in FIG. 6, together with the state where the drawer is drawn out in FIG. 7). Therefore, when the feeding object is moved out of the first opening E1, the feeding object is stopped by the stopping part 152 and located in a space 156 in the drawer 150. When the drawer 150 is pushed back into and partially concealed in the base 110, the stopper 152 is substantially located (and concealed) below the first opening E1. Accordingly, in a state where the drawer 150 is drawn out of the base 110, the pet feeding device 100 is able to provide a greater accommodating and buffering space for the feeding objects dropped out of the container 120, and prevent the feeding objects from being dispersed at various places.

In view of the foregoing, in the embodiments of the disclosure, with a vertical corresponding arrangement of the container and the transmission tunnel and the second opening of the container having an opening size adjustable through the movable baffle, the user may place the feeding objects into the container via the second opening and adjust and the second opening of the pet feeding device to a desired opening size, so as to limit the amount of the feeding objects dropped via the second opening. Therefore, when the container is driven by the driving assembly of the pet feeding device to rotate about an axis and the second opening is moved past the transmission tunnel, the feeding object in the container may be moved out of the container (i.e., dropped out of the container) via the second opening. In addition, the dropped feeding object may be moved out via the first opening through the transmission tunnel for the pet to eat.

Besides, as the control module is able to further control the number of circles that the container rotates, with the desired opening size of the second opening, the amount of the feeding objects dropped may be controlled. Meanwhile, as the drawer and the stopper are disposed at the bottom of the base, when the drawer is drawn out of the base, the feeding object may still be stopped by the stopper when exiting the first opening. Therefore, the additional buffering and feeding space of the feeding objects is provided, so as to prevent the feeding objects from being dispersed at various places.

Moreover, the pet feeding device further includes the audio-visual module. The audio-visual module may provide the corresponding audio-visual signal in correspondence with the rotation mode of the container and the state of the drawer, so as to draw the pet's attention and achieve a training purpose.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pet feeding device, comprising:
a base, having a first opening;
a transmission tunnel, disposed inside the base and in communication with the first opening;
a driving assembly, disposed inside the base; and
a container, disposed inside the base and having a rotating shaft connected with the driving assembly to be driven to rotate in the base, wherein the container has a second opening having an adjustable opening size, the transmission tunnel is located on a movement path of the second opening, a feeding object is adapted to be received by the container via the second opening, the feeding object is dropped to the transmission tunnel via the second opening when the container is rotated to move the second opening past the transmission tunnel, and the feeding object is moved out via the first opening along the transmission tunnel.

2. The pet feeding device as claimed in claim 1, wherein the container comprises:
a body, having a space, the rotating shaft, and the second opening, wherein the space receives the feeding object, the rotating shaft extends outward from the body; and
a baffle, movably connected to the body and located at the second opening, wherein the baffle is configured to open or close the second opening and adjust the opening size of the second opening.

3. The pet feeding device as claimed in claim 2, wherein the body comprises a plurality of positioning notches located on an inner wall of the body, the baffle has a positioning protrusion, the positioning notches are arranged along a movement path of the positioning protrusion, and the positioning protrusion is temporarily engaged to one of the positioning notches during movement of the baffle.

4. The pet feeding device as claimed in claim 1, further comprising:
a drawer, movably disposed at a bottom of the base to be accommodated in or drawn out of the base, wherein when the drawer is accommodated in the base, an outer surface of the drawer partially surrounds the first opening and conforms to a profile of an outer surface of the base.

5. The pet feeding device as claimed in claim 4, wherein the drawer has a stopper, and when the drawer is drawn out of the base, the stopper is located on a movement path of the feeding object, such that the feeding object is stopped by the stopper and located in the drawer when the feeding object is moved out of the first opening.

6. The pet feeding device as claimed in claim 1, further comprising:
a control module, electrically connected with the driving assembly; and
an audio-visual module, electrically connected with the control module, wherein the audio-visual module provides an audio-visual signal under control of the control module when the driving assembly drives the container to rotate under control of the control module.

7. The pet feeding device as claimed in claim 6, further comprising:
a sensor, disposed inside the base and electrically connected with the control module; and
a poke block, disposed inside the base and rotated synchronously with the rotating shaft, wherein the sensor is located on a movement path of the poke block, and when the sensor contacts and senses the poke block, the driving assembly stops driving the container, such that the second opening faces upward and the transmission tunnel is located exactly below the container.

8. The pet feeding device as claimed in claim 1, further comprising a transparent top cover assembled to the base.

9. The pet feeding device as claimed in claim 1, wherein the container is spherical.

10. The pet feeding device as claimed in claim 1, wherein the container is transparent.
